(19) United States
(12) Patent Application Publication
(10) Pub. No.: US 2006/0146406 A1
(43) Pub. Date: Jul. 6, 2006

(54) Display device and optical motor for such a device

(76) Inventor: Pascal Benoit, Liffre (FR)

Correspondence Address: Joseph S Tripoli;Thomson Licensing Inc, Patent Operations, PO Box 5312, Princeton, NJ, 08543-5312, US

(21) Appl. No.: 10/562,231

(22) PCT Filed: Jun. 23, 2004
(86) PCT No.: PCT/EP04/06981

§ 371 Date: Dec. 21, 2005

(30) Foreign Application Priority Data
Jul. 1, 2003 (FR) 0307956

(51) Int. Cl. G02B 27/28

(52) U.S. Cl. 359/501; 359/495

(57) ABSTRACT

A display device comprises an illumination system that generates a light beam of variable colour along an illumination axis, and an optical motor. The optical motor generates a polarised light beam and comprises a matrix imager, each pixel of which reflects the light beam with a polarization that depends on the image to be generated in the colour received, a first polarization splitter capable of transmitting a polarization of the light beam of variable colour and of at least partly transmitting the beam reflected by the imager in another direction, and a second polarization splitter capable of transmitting the said polarization of the light beam of variable colour.

The invention relates to a display device and to an optical motor for such a device.

In a known design, a display device comprises an illumination system that generates a light beam, the colour of which varies periodically over time, generally with three colours used in video, namely red, green and blue. The light beam passes through a polarization splitter that transmits, towards a matrix imager (or matrix modulator), a single polarization of the light, for example only the p-polarized light beams.

The matrix imager reflects the entire incident light beam but, at each point in the reflecting beam, the polarization (induced by the elements or pixels of the imager) depends on the light intensity that it is desired to display in the colour of the incident beam at the instant in question.

For example, a pixel to be displayed that is on will reflect an s-polarized light ray. Such a ray will then be reflected by the polarization splitter towards the imaging means for display on the screen of the display device. In contrast, a pixel to be displayed that is black will return a p-polarized light ray. Such a ray will therefore pass through the polarization splitter without being reflected (but transmitted) and will therefore not reach the imaging means, nor the screen of the display device.

In theory, the luminosity of each pixel of the screen may thus be perfectly controlled, and to do so in the colour in question at each instant. Of course, practical implementation does not allow as perfect a result. For example, the angular spread of the beam reduces the polarization purity, thereby resulting in particular in slight light leakage for a pixel to be in the off state, and thus in poor contrast.

The invention aims to improve the practical implementation of such a system in order to make it approach its theoretical capabilities, and especially to increase its contrast.

The invention proposes a display device comprising:
an illumination system that generates a light beam of variable colour along an illumination axis;
a matrix imager, each pixel of which reflects the light beam with a polarization that depends on the image to be generated in the received colour, the reflecting beam being said modulated beam; and
a first polarization splitter adapted to transmit a polarization of the light beam of variable colour in a first direction towards said matrix imager and to transmit, at least partially, said modulated beam in a second direction, modulated beam being polarised; and
a second polarization splitter adapted to transmit the said polarization of the light beam of variable colour in a third direction towards the first polarisation splitter.

By using two polarization splitters, the polarization purity of the beam received by the matrix imager of such a display device is thus particularly high.

Preferably, the splitting surface of the second polarization splitter is crossed by the polarization of the light beam of variable colour, which is transmitted in the third direction and the splitting surface of the first polarization splitter is crossed by the polarization of the light beam of variable colour, which is transmitted in the first direction, and reflects the polarization of the modulated beam, which is transmitted in the second direction.

Preferably, the splitting surface of the first polarization splitter makes with the light beam an angle having a defined value in a first plane containing the light beam and in which the splitting surface of the second polarization splitter makes with the light beam an angle having an opposite value to the defined value in a second plane containing the light beam and parallel to the first plane.

This arrangement allows the polarization purity to be further improved, as will be described in detail later.

For example, a defined value equal to 45° will be used.

In one particularly practical arrangement, the first polarization splitter and the second polarization splitter are arranged symmetrically with respect to a plane perpendicular to the illumination axis.

Preferably, the splitting surface of the first polarization splitter and the splitting surface of the second polarization splitter thus make between them an angle having an absolute value of about 90°.

In one particularly simple embodiment, the matrix imager lies on the illumination axis. Preferably, the first polarization splitter at least partly reflects the beam reflected by the imager in the direction of imaging means for display on a screen.

In a preferred solution, the colour of the light beam varies periodically among a plurality of colours and, more precisely, the light beam is of three different colours successively in each period.

According to one possibility, the illumination means comprise at least two colour filters, the light beam passing periodically through each colour filter.

The invention also proposes an optical motor for such a display device. This optical motor is thus adapted to receive a light beam of variable colour along an illumination axis, comprising:
a matrix imager, each pixel of which reflects the light beam with a polarization that depends on the image to be generated in the received colour, the reflecting beam being said modulated beam;
a first polarization splitter adapted to transmit a polarization of the light beam of variable colour in a first direction towards said matrix imager and to transmit, at least partially, said modulated beam in a second direction; and
a second polarization splitter (20) adapted to transmit the said polarization of the light beam of variable colour in a third direction towards the first polarisation splitter;
   the optical motor being adapted to transmit a polarised modulated beam.

Preferably, the splitting surface of the second polarization splitter is crossed by the polarization of the light beam of variable colour, which is transmitted in the third direction and the splitting surface of the first polarization splitter is crossed by the polarization of the light beam of variable colour, which is transmitted in the first direction, and reflects the polarization of the modulated beam, which is transmitted in the second direction.

Other features and advantages of the invention will become apparent in the light of the detailed description that follows, given with reference to the appended figures in which:

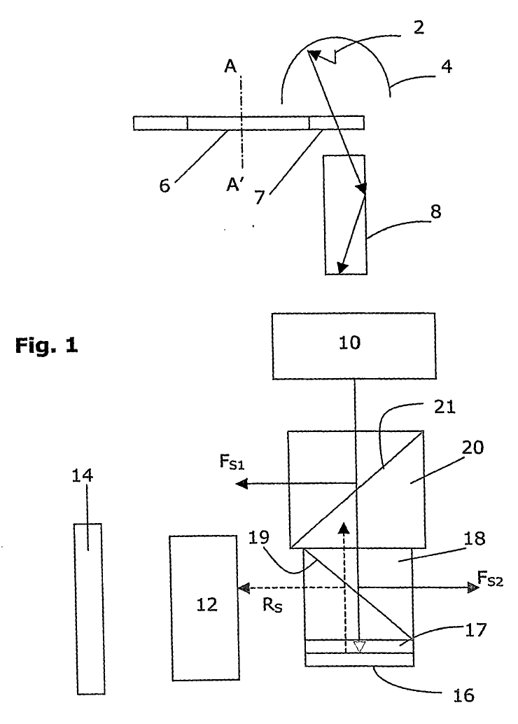

FIG. 1 shows the main elements of a display device incorporating the teachings of the invention;

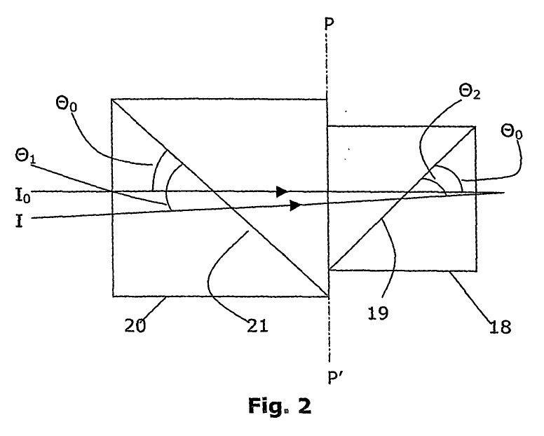

FIG. 2 is a diagram explaining the optical behaviour of two polarization splitters for horizontal light rays.

The display device shown in FIG. 1 has a light source 2 located at the focus of a reflector 4, for example at the first focus of an elliptical reflector.

Placed in the region of the second focus of the reflector 4 is a rod 8 that acts as an integrating light pipe. Before the light beam emanating from the reflector 4 enters the rod 8, it passes through a colour filter 7 carried by a wheel 6.

The wheel 6 carries, around its periphery, a plurality of colour filters, for example filters for the three colours red, green and blue that are used in video. In operation, the rotation of the wheel 6 about its axis AA′ therefore allows the light beam to be periodically coloured.

The light beam of periodically variable colour is therefore transmitted through the rod 8 so as to form, on the end face of the latter, a secondary light source with appropriate dimensions.

The light beam is then transmitted to the optical motor of the display device through a first imaging system 10 consisting of lenses. The light source 2, the reflector 4, the filter 7 (which varies in colour by rotation of the wheel 6), the rod 8 and the first imaging system 10 thus produce, in the case of the optical motor, an illumination system that generates a light beam of variable colour.

According to one possible embodiment, the illumination system includes means for polarizing the light so that the light beam of variable colour that it emits is also polarized, preferably p-polarized.

The optical motor converts the light beam emitted by the illumination system into a beam modulated by the image to be displayed, as will be described in more detail below.

The optical motor comprises an entry polarization splitter 20 lying on the optical axis or illumination axis (i.e. in the general direction of the light beam emitted by the illumination system) and the splitting surface 21 of which makes an angle of 45° with the optical axis. In one embodiment in which the optical axis is horizontal (i.e. the light beam emitted is generally horizontal), the splitting surface 21 lies more precisely in a vertical plane that makes an angle of −45° with the optical axis in the horizontal plane containing the light beam. (The negative angle expresses a rotation in the clockwise direction about the optical axis, as is clearly visible in FIG. 1.) The p-polarized rays of the light beam are therefore (for the most part) transmitted by the entry polarization splitter 20 along the optical axis, whereas the s-polarized rays are (for the most part) reflected by the splitting surface 21 of the splitter 20 into a flux Fₛ₁, which reflected rays leave the main light beam.

As was already pointed out, owing to the angular spread of the light beam (necessary in practice), all the s-polarized rays of the light beam cannot have an angle of incidence with respect to the splitting surface 21 that allows total reflection and that a small portion of the s-polarized light flux is thus transmitted by the polarization splitter 20.

Immediately downstream of the entry polarization splitter 20 on the optical axis (and preferably in contact with the entry polarization splitter 20), the optical motor has a main polarization splitter 18.

The splitting surface 19 of the main polarization splitter 18 makes an angle of 45° with the optical axis and, more precisely, in the configuration mentioned above (with the optical axis horizontal), the splitting surface 19 of the main splitter 18 lies in a vertical plane that makes an angle of +45° with the optical axis in the horizontal plane containing the optical axis.

Preferably, and as will be explained in detail later, the entry splitter 20 and the main splitter 18 are arranged symmetrically with respect to a plane perpendicular to the optical axis (like the contact plane of the two splitters 18, 20), i.e. their respective splitting planes 19, 21 are symmetrical with respect to a plane perpendicular to the optical axis. Put more simply, the splitters 18, 20 may be said to be opposed or back to back.

As is clearly visible in FIG. 1, the splitting planes 21, 19 of the entry splitter 20 and of the main splitter 18 therefore make between them an angle of about 90° in projection in a horizontal plane. The p-polarized light beam received from the entry splitter 20 is thus essentially transmitted by the main splitter 18 into a quarterwave plate 17/imager 16 assembly placed on the opposite face of the main splitter 18 from the entry splitter 20, which assembly forms the optically active part of the optical motor. In a manner similar to what was already described in the case of the entry splitter 20, a portion of the s-polarized light flux is essentially reflected by the main splitter 18 into a beam Fₛ₂, which leaves the optical axis and is not used thereafter, but a small portion of the s-polarized flux that enters the main splitter 18 is transmitted by the latter towards the imager 16.

However, this portion represents a minute portion of the s-polarized flux initially generated by the illumination system by passing through the two splitters 18, 20. The ratio of the amount of p-polarized light to the amount of s-polarized light is therefore very high at the exit of the main splitter 18, thereby guaranteeing good contrast of the display device, as will be understood in the following.

The imager 16 is a liquid-crystal matrix reflective imager. Each pixel (or element) of the imager 16 is driven by an electronic system (not shown) in such a way that the configuration of the liquid crystals of the pixel impresses a defined polarization on the ray that it reflects, this polarization depending on the luminosity that the corresponding pixel in the image to be displayed must have.

The electronic system is especially synchronized with the illumination system (in this case with the wheel 6) in such a way that the imager 16 generates at each instant, owing to its multiple elements, the (monochrome) image to be displayed in the colour of the light beam emitted by the illumination means at this instant. The images of the various colours (in this case red, green and blue) are thus generated at very closely separated successive instants, not detectable by the human eye, in such a way that the latter does not see the superposition of the various images, which corresponds to the coloured image to be displayed.

More precisely, in a pixel of the imager 16, a p-polarized incident light ray will be reflected into an s-polarized light ray by the quarterwave plate 17/imager 16 assembly if the corresponding pixel of the image (in the colour of the light beam at the instant in question) has to be in the on state (maximum luminance). Thus, the reflected light ray will then be reflected by the splitting surface 19 of the main splitter 18 towards the second imaging means 12 (the flux Rₛ perpendicular to the optical axis). The second imaging means 12, which mainly comprise lenses, allow the entire reflected flux R_{S} (which corresponds to all of the s-polarized rays reflected by the imager 16) to be imaged on the screen 14 of the display device. On the other hand, when a pixel has to be in the off state (i.e. black, at least in the colour of the light beam at the instant in question), the pixel of the imager 16 combined with the quarterwave plate 17 reflects a p-polarized incident ray as such, so that it is not reflected by the main splitter 18 towards the second imaging means 12 but transmitted along the optical axis, in a direction opposite that of the light beam generated by the illumination system. Such a light ray therefore does not~contribute to the illumination of the screen, as is moreover desired.

One of the advantages of the system that has just been described will now be explained in greater detail with reference to FIG. 2, which shows the passage of a first horizontal light ray I₀ and a second horizontal light ray I through the polarization splitters 18, 20.

The light ray I₀ (generated by the illumination system) is directed along the optical axis, and, therefore is incident on the splitting surfaces 21, 19 of the entry splitter 20 and of the main splitter 18 at an angle ⊖₀ equal to 45° (in absolute value).

The light ray I (also generated by the illumination system) is itself also horizontal, but makes a non-zero angle with the ray I₀. The light ray I therefore has a slight inclination in the horizontal plane relative to the optical axis.

Owing to the symmetrical arrangement of the entry polarization splitter 20 and the main polarization splitter 18 with respect to the contact plane PP′ of the splitters 18, 20, which is perpendicular to the optical axis, the ray I is incident on the splitting surface 21 of the entry splitter 20 at an angle ⊖₁ that is slightly greater than ⊖₀ (=45°) and on the splitting surface 19 of the main splitter 18 with an angle ⊖₂ slightly less than ⊖₀ (=45°).

Similarly, an incident ray passing through the splitting surface 21 of the entry splitter 20 with an angle of incidence slightly less than 45° will be incident on the splitting surface 19 of the main splitter 18 with an angle slightly greater than 45°.

This makes it possible to overcome the dissymmetry of the behaviour of the polarization splitters in reflection and in transmission about 45°. The successive passage through the two polarization splitters 18, 20 arranged as indicated above makes the behaviour of the incident rays symmetrical about 45°, in particular if the optical behaviour of the two splitters 18, 20 is the same.

For example, if the splitters 18, 20 have an extinction angle of 47° (i.e. the s-polarized rays are totally reflected for an angle of incidence of 47° and therefore very weakly transmitted for angles of incidence between 45° and 50°), a light ray making an angle of between 0° and 5° with the optical axis will necessarily be incident on one of the two splitters 18, 20 with an angle of incidence between 45° and 50°, which guarantees very low transmission of the s-polarized rays by the combination of the two splitters 18, 20.

The polarization purity of the beam is therefore ensured not only by the juxtaposition of the two splitters 18, 20, but also by their advantageous arrangement described above.

It should also be pointed out that this solution is particularly advantageous in the context of the device described above, in which the main splitter 18 is also used for reflecting the s-polarized light rays emanating from the imager towards the second imaging means 12. This is because the improvement in the polarization purity generated by the invention allows much greater tolerance on the extinction of the s polarization in transmission, thereby making it possible to choose a main splitter 18 exhibiting very good extinction of the p polarization in reflection.

To confirm the analysis developed above, the contrast for various relative configurations of the entry polarization splitter and the main polarization splitter has been calculated by simulation.

In the three configurations tested here, the following lie on the horizontal illumination axis of the illumination system, in this order:
the entry polarization splitter;
the main polarization splitter; and
the matrix imager. In addition, the splitting surface of the main splitter makes an angle of 45° with the illumination axis in the horizontal plane containing this axis.

In Configuration 1 (T2-0), the splitting surface of the entry splitter is parallel to the splitting surface of the main splitter. In Configuration 2 (T2-180), the entry splitter has undergone a 180° rotation about the illumination axis compared to Configuration 1, and its splitting surface therefore makes an angle of −45° with the illumination axis, i.e. the splitting surfaces of the two splitters are symmetrical with respect to a plane perpendicular to the illumination axis, as is preferably proposed by the invention.

In Configuration 3 (RT-90), the entry splitter has undergone a 90° rotation about the illumination axis with respect to Configuration 1.

The results below are given in the absence of prepolarization of the light by the illumination system.

The simulations were carried out with several types of polarization splitter:
type I: strong extinction ; manufacturer I;
type II: strong extinction, manufacturer II;
type III: strong transmission, manufacturer I;
type IV: strong extinction, manufacturer II.

The contrast values obtained (ratios of the luminosity of a lit pixel to an unlit pixel, integrated over the −10° to 10° range, i.e. a 2.8 aperture) are given in the table below.

| Splitter type | Configuration 1 | Configuration 2 | Configuration 3 |
|---|---|---|---|
| Type I | 5397 | 8627 | 4072 |
| Type II | 1752 | 2382 | 1454 |
| Type III | 2841 | 5353 | 1160 |
| Type IV | 1600 | 2387 | 752 |

Although these values are theoretical contrast values calculated in the case of a perfect imager and for a monochromatic beam, they clearly illustrate the benefit of Configuration 2.

The above description is given as non-limitative possible embodiments of the invention.

For example, according to different variants of the invention, the display device or the optical motor comprise two polarization splitters, which can be positioned in different configurations.

Thus, the second splitter splits the light beam of variable colour according to two directions: one polarization crosses the splitting surface of the second splitter and the other polarisation is reflected by this splitting surface. Only one of these polarizations is used. Thus, the second splitter transmits the light beam of variable colour according to one direction towards the first splitter; this direction corresponds either to polarization crossing the splitting surface or to reflected polarization according to the relative location of the polarization splitters.

The first splitter splits also the light beam of variable colour according to two directions and the modulated light beam corresponding to the light beam of variable colour which is reflected by the imager: again, one polarization crosses the splitting surface of the first splitter and the other polarization is reflected by this splitting surface. For each of these beams (light beam of variable colour and modulated beam), only one of these polarizations is used. Thus, the first splitter transmits the light beam of variable colour according to one direction towards the imager; this direction corresponds either to polarization crossing the splitting surface or to reflected polarization according to the relative location of the polarization splitters. In addition, the first splitter transmits the light beam of variable colour according to one direction towards imaging means for display on a screen; this direction corresponds either to polarization crossing the splitting surface or to reflected polarization according to the relative location of the polarization splitters. As the imager changes the polarization, the direction of transmission of the light beam by the first splitter is not same as the same the direction of transmission of the modulated beam; thus, the modulated beam is not transmitted towards the second splitter.

In addition, the splitting surface of the first polarization splitter makes with the light beam an angle having a defined value in a first plane containing the light beam and in which the splitting surface of the second polarization splitter makes with the light beam an angle having preferably an opposite value to the defined value in a second plane containing the light beam and parallel to the first plane. Nevertheless, the splitting surface of the second polarization splitter makes an angle with the light beam, which is not necessary opposite to the defined value: for example, it can be equal.

Furthermore, according to the invention, polarization splitters and their splitting surface can be oriented in different relative directions. For example, the planes defined by polarization beams respectively reflected by splitting surface or crossing it, can be different for each of polarization splitters (eg if the splitter 18 of FIG. 1 is rotated by 90° along a vertical axis).

1. Display device comprising:
an illumination system that generates a light beam of variable colour along an illumination axis;
a matrix imager (16), each pixel of which reflects the light beam with a polarization that depends on the image to be generated in the received colour, the reflecting beam being said modulated beam; and
a first polarization splitter (18) adapted to transmit a polarization of the light beam of variable colour in a first direction towards said matrix imager and to transmit, at least partially, said modulated beam in a second direction; characterized by:
a second polarization splitter (20) adapted to transmit the said polarization of the light beam of variable colour in a third direction towards the first polarisation splitter;
modulated beam being polarised.

2. Display device according to claim 1, characterized in
the splitting surface (21) of the second polarization splitter (20) is crossed by the polarization of the light beam of variable colour, which is transmitted in the third direction
the splitting surface (19) of the first polarization splitter (18) is crossed by the polarization of the light beam of variable colour, which is transmitted in the first direction, and reflects the polarization of the modulated beam, which is transmitted in the second direction.

3. Display device according to one of claims 1 and 2, in which the splitting surface (19) of the first polarization splitter (18) makes with the light beam an angle having a defined value in a first plane containing the light beam and in which the splitting surface (21) of the second polarization splitter (20) makes with the light beam an angle having an opposite value to the defined value in a second plane containing the light beam and parallel to the first plane.

4. Display device according to claim 3, in which the defined value is equal to 45°.

5. Display device according to one of claims 1 to 4, in which the first polarization splitter (18) and the second polarization splitter (20) are arranged symmetrically with respect to a plane (PP′) perpendicular to the illumination axis.

6. Display device according to one of claims 1 to 4, in which the splitting surface (19) of the first polarization splitter (18) and the splitting surface (21) of the second polarization splitter (20) make between them an angle having an absolute value of about 90°.

7. Display device according to one of claims 1 to 6, in which the matrix imager (16) lies on the illumination axis.

8. Display device according to one of claims 1 to 7, in which the first polarization splitter (18) at least partly transmit said modulated beam in the direction of imaging means (12) for display on a screen (14).

9. Display device according to one of claims 1 to 8, in which the colour of the light beam varies periodically among a plurality of colours.

10. Display device according to one of claims 1 to 9, in which the illumination means comprise at least two colour filters (7), the light beam passing periodically through each colour filter (7).

11. Display device according to either of claims 9 and 10, in which the light beam is of three different colours successively in each period.

12. Optical motor adapted to receive a light beam of variable colour along an illumination axis, comprising:
a matrix imager (16), each pixel of which reflects the light beam with a polarization that depends on the image to be generated in the received colour, the reflecting beam being said modulated beam ; and
a first polarization splitter (18) adapted to transmit a polarization of the light beam of variable colour in a first direction towards said matrix imager and to transmit, at least partially, said modulated beam in a second direction; characterized by:
a second polarization splitter (20) adapted to transmit the said polarization of the light beam of variable colour in a third direction towards the first polarisation splitter; and
the optical motor being adapted to transmit a polarised modulated beam.

13. Optical motor according to claim 12, characterized in
the splitting surface (21) of the second polarization splitter (20) is crossed by the polarization of the light beam of variable colour, which is transmitted in the third direction
the splitting surface (19) of the first polarization splitter (18) is crossed by the polarization of the light beam of variable colour, which is transmitted in the first direction, and reflects the polarization of the modulated beam, which is transmitted in the second direction.

14. Optical motor according to one of claim 12 and 13, in which the splitting surface (19) of the first polarization splitter (18) makes with the light beam an angle of a defined value in a first plane containing the light beam and in which the splitting surface (21) of the second polarization splitter (20) forms with the light beam an angle having an opposite value to the defined value in a second plane containing the light beam and parallel to the first plane.

15. Optical motor according to claim 14, in which the defined value is equal to 45°.
